(19) United States
(12) Patent Application Publication
(10) Pub. No.: US 2020/0096090 A1
(43) Pub. Date: Mar. 26, 2020

(54) Liquid injection into a Continuously Variable Transmission (CVT) for the purpose of cooling the drive belt and CVT.

(71) Applicant: Kyle Thomas Vestermark, Aliso Viejo, CA (US)

(72) Inventor: Kyle Thomas Vestermark, Aliso Viejo, CA (US)

(21) Appl. No.: 16/582,805

(22) Filed: Sep. 25, 2019

Related U.S. Application Data
(60) Provisional application No. 62/736,449, filed on Sep. 25, 2018.

(51) Int. Cl. F16H 57/04; F16H 37/02

(52) U.S. Cl. CPC F16H 57/0489; F16H 57/0412; F16H 37/021; F16H 57/0404; F16H 2037/023; F16H 57/045; F16H 57/0473; F16H 2200/0034; F16H 2702/00; F16H 57/0416

(57) ABSTRACT

Cooling of the drive belt in a CVT achieved through the injection of liquid into any portion of the CVT housing and/or CVT air intake of a utility vehicle (UTV) or Side-by-side (SXS), which may include an ATV or any other vehicle utilizing a CVT and drive belt.

### FIELD OF THE INVENTION

This invention relates to continuously variable transmissions (CVT's) used by UTV's, and specifically the cooling of the drive belt and CVT components through liquid injection.

### BACKGROUND OF THE INVENTION

Continuously variable transmissions (CVT's), side-by-side vehicles (SXS's) and utility vehicles (UTV's) are known as are the components that make up these vehicles including the CVT's. The present disclosure relates to UTV's. The present disclosure relates to the cooling of CVT's.

This liquid injection system was conceived due to the CVT drive belt in a UTV being a failure point of the vehicle when operated under extreme conditions such as, but not limited to, sand, mud, snow; racing; carrying heavy loads; towing, climbing, high altitude; high ambient temperature, and etc. Under these conditions, which may include one or several of them at the same time, the drive belt tends to overheat and fail because most OEM clutches do not provide enough air flow to keep the belt within its recommended temperature operating range.

There are several aftermarket companies that have attempted to address this problem using larger volume CVT housings, additional air cooling vents in the CVT housings, primary and secondary clutches that pump at greater than the OEM air flow rate and electric or engine powered air fans/blowers installed on the CVT housing air intake and/or air discharge to facilitate increased air flow.

All previous attempts at mitigating the cooling of the drive belt and the CVT have been through the manipulation of air.

### SUMMARY OF THE INVENTION

A liquid injection cooling system for the drive belt and CVT components contained within a CVT housing of a UTV. The injected liquid facilitates the cooling of the CVT components and specifically the drive belt when the UTV is operated under extreme conditions.

The reason for preventing the failure of the drive belt is predominantly cost. The cost of a drive belt failure includes the cost of the belt, the labor cost to replace the belt, the recovery of the UTV from the location of failure if the operator is unable to fix it in place, and, but not limited to the damage that a failed drive belt can cause to the CVT housing, clutches and power unit/transmission seals. Additionally, there can be health consequences for the operator of the UTV if the failure occurs in an inaccessible location during high or low temperatures and etc.

While no single component contained in this liquid injection system is new or unique, the process in which these components are combined, for the specific purpose of cooling the drive belt and CVT components with liquid, is unique and exemplary.

### BRIEF DESCRIPTION OF THE DRAWINGS

FIG. 1: is a piping and instrumentation diagram of the exemplary liquid injection system.

FIG. 2: illustrates a representative view of a drive train of a UTV, including the liquid injection system

### DETAILED DESCRIPTION OF THE DRAWINGS

The embodiments disclosed below are not intended to be exhaustive or to limit the invention to the precise forms disclosed in the following detailed description. Rather, the embodiments are chosen and described so that others skilled in the art may utilize their teachings. While the present disclosure is primarily directed to a side-by-side vehicle, the features disclosed herein may have application to other types of vehicles such as all-terrain vehicles, motorcycles, watercraft, snowmobiles, and golf carts.

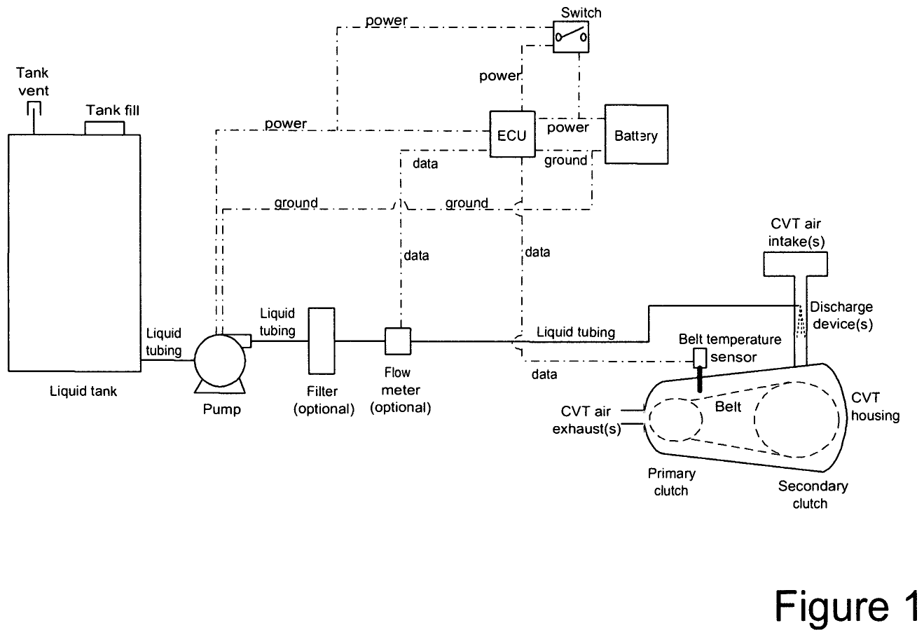

FIG. 1 is an illustrative embodiment of the liquid injection system. It represents the interaction between the tank, pump, liquid tubing and discharge device(s) with the CVT. It further represents the instrumentation and activation device(s) for triggering the liquid injection system.

Referring to FIG. 1, the tank is shown with a vent and fill port and is connected to the pump with liquid tubing which is further connected to the discharge devices.

Referring to FIG. 1, the components of the electrical system for controlling and activating the liquid injection system are the battery, switch, belt temperature sensor and ECU.

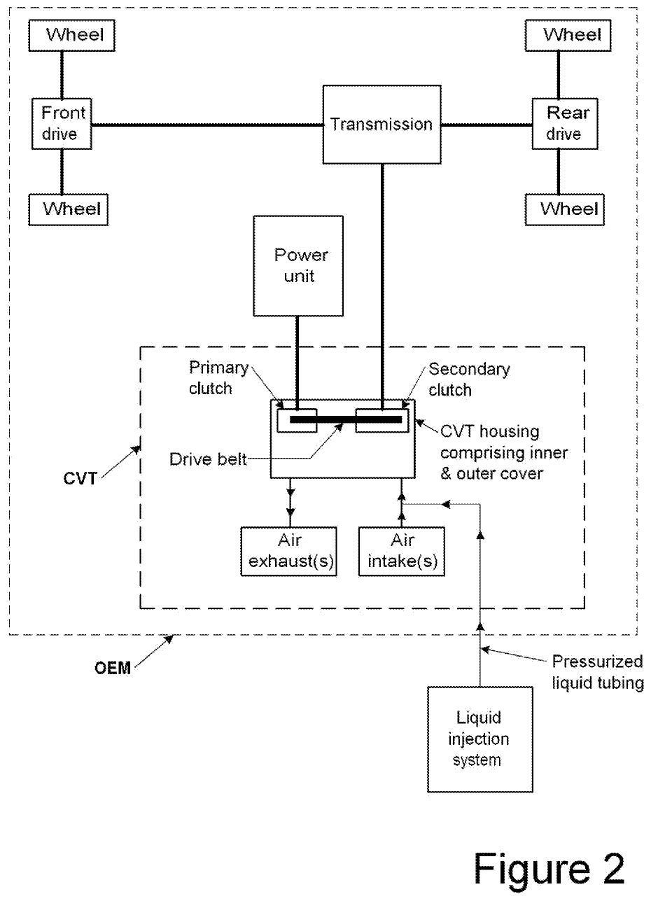

FIG. 2 depicts the original equipment manufacturer (OEM) components of a UTV. These components include a power unit coupled to a CVT, a transmission coupled to a CVT, the CVT, and front and rear drive components coupled to wheels.

Referring to FIG. 2, the CVT is further shown as containing a primary clutch coupled to the power unit, a secondary clutch coupled to a transmission, the drive belt coupled between the primary and secondary clutch, air intakes and exhausts, and the CVT housing which includes an inner and outer cover.

Referring to FIG. 2, the liquid injection system is shown connected to the CVT air intake with pressurized liquid tubing.

While this invention has been described as having an exemplary design it may be further enhanced within the spirit and scope of this disclosure. This application is intended to cover any variations, uses, or adaptations of the invention using its general principles. Additionally, this application is intended to cover such modifications from the present disclosure as come within known or customary practice in the art to which this invention exists.

The exemplary embodiments of the invention in which an exclusive property or privilege is claimed are defined as follows:

1. A vehicle, herein after referred to as a UTV, having a power unit connected to a transmission through the use of a CVT, comprising of a liquid injection system, comprising of a storage vessel of said liquid, a pump to pressurize said liquid, device(s) to discharge said liquid, tubing to transport said liquid, an activation device, a power source such as a battery and may include a liquid filter, flow meter, temperature sensor, power unit RPM sensor and/or a vehicle speed sensor.

2. The power unit of claim 1, typically comprises an internal combustion engine and ancillary equipment necessary for said engine, but may include an electric motor, all of which is supplied by the OEM of the UTV and is connected to the transmission via a CVT and drive belt.

3. The transmission of claim 1, typically comprises a high speed, low speed and reverse gear, but may include a manual clutched gear box or an automatic transmission, all of which is supplied by the OEM of the UTV and is connected to the power unit via a CVT and drive belt.

4. The CVT of claim 1, comprising of a drive belt connected between a drive or output pulley, herein referred to as the primary clutch connected to the power unit and a driven or input pulley, herein referred to the secondary clutch connected to the transmission, said CVT further comprises a housing comprising of filtered or non-filtered cooling air intake(s), air exhaust(s), an inner cover, and an outer cover connected to the inner cover to provide protection from dust, rocks, debris and water from infiltrating into the interior chamber containing the primary and secondary clutch assembly and drive belt.

5. The clutch assembly of claim 4, typically comprises an integrated air fan on one or both clutches to facilitate the cooling of the clutch assembly and drive belt through the heat transfer of air that is forced by the clutch fans through the interior chamber of the housing.

6. The liquid reference of claim 1, typically comprises water, but may include a mixture of other liquids to enhance cooling.

7. The storage vessel of claim 1, comprises of a liquid container comprising of a means of filling said container, a means of venting said container, a liquid discharge fitting and a means of mounting said container.

8. The storage vessel of claim 7, may comprise of an integrated pump mounted in or on said vessel.

9. The pump of claim 1, comprises of a liquid transfer pump with a suction inlet and discharge outlet.

10. The pump of claim 9, further comprises of electric connections to power said pump.

11. The pump of claim 9, may be mounted in or on the storage vessel of claim 7 or mounted in a separate location from the storage vessel of claim 7.

12. The liquid discharge device(s) of claim 1, comprises of the means to discharge the pumped liquid from claim 6 into the CVT of claim 4.

13. The liquid discharge device(s) of claim 12, may be installed at any location within the CVT of claim 4 to provide cooling of the CVT and drive belt.

14. The liquid discharge device(s) of claim 12, are typically installed into the CVT cooling air intake hose(s), but may be installed into the CVT inner or outer cover or any other location that allows discharged liquid to facilitate the cooling of the CVT and drive belt.

15. The tubing of claim 1, comprises of either flexible liquid tubing or metallic tubing/piping to transport said liquid from the storage vessel of claim 7 to the pump of claim 9 and to the discharge device(s) of claim 12.

16. The tubing of claim 15, may comprise of fittings to reduce or increase the diameter of said tubing.

17. The activation device of claim 1, may comprise a manual switch, contact closure from a drive belt temperature sensing device, programmable circuit, engine control unit (ECU), or any other means of activating and turning off the system based on belt temperature, vehicle speed, power unit RPM, ambient air temperature, and or occupant input.
